(19) United States
(12) Patent Application Publication
(10) Pub. No.: US 2024/0323849 A1
(43) Pub. Date: Sep. 26, 2024

(54) METHOD FOR SELECTING WAKE-UP SIGNAL FORMAT AND DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/732,267

(22) Filed: Jun. 3, 2024

Related U.S. Application Data
(63) Continuation of application No. PCT/CN2021/136907, filed on Dec. 9, 2021.

(51) Int. Cl. H04W 52/02; H04W 24/08

(52) U.S. Cl. CPC H04W 52/0235; H04W 24/08

(57) ABSTRACT

Provided is a method for selecting a wake-up signal format. The method includes: selecting, by a terminal device, a target wake-up signal format from a plurality of different wake-up signal formats based on a signal quality measurement result regarding a downlink signal; wherein the different wake-up signal formats correspond to different quantities of repetitive signal transmissions; and waking up the terminal device based on the target wake-up signal format.

### CROSS-REFERENCE TO RELATED APPLICATION

This application is a continuation application of International Application No. PCT/CN2021/136907, filed on Dec. 9, 2021, the entire contents of which are incorporated herein by reference.

### TECHNICAL FIELD

Embodiments of the present disclosure relate to the technical field of communications, and in particular, relate to a method and an apparatus for selecting a wake-up signal format, and a device and a storage medium.

### BACKGROUND

Currently, in order to achieve power saving of a terminal device, the terminal device may be equipped with two receivers, i.e., a primary receiver and a secondary receiver. The power consumption of the secondary receiver is lower than the power consumption of the primary receiver. When the terminal device is in a low power consumption state, the primary receiver is turned off, and the secondary receiver is turned on. After receiving a wake-up signal from a network device through the secondary receiver, the terminal device turns on the primary receiver to monitor a paging message, so as to achieve the purpose of energy saving.

### SUMMARY

Embodiments of the present disclosure provide a method and an apparatus for selecting a wake-up signal format, and a device and a storage medium. The technical solutions are as follows.

According to some embodiments of the present disclosure, a method for selecting a wake-up signal format is provided. The method includes:
selecting, by a terminal device, a target wake-up signal format from a plurality of different wake-up signal formats based on a signal quality measurement result regarding a downlink signal; wherein the different wake-up signal formats correspond to different quantities of repetitive signal transmissions; and
waking up the terminal device based on the target wake-up signal format.

According to some embodiments of the present disclosure, a method for selecting a wake-up signal format is provided. The method includes:
selecting, by a network device, a target wake-up signal format from a plurality of different wake-up signal formats based on a signal quality measurement result regarding a downlink signal reported by a terminal device; wherein the different wake-up signal formats correspond to different quantities of repetitive signal transmissions, and the target wake-up signal format is configured to wake up the terminal device; and
sending, by the network device, the target wake-up signal format to the terminal device.

According to some embodiments of the present disclosure, a method for waking up a terminal device is provided. The method includes:
reporting, by the terminal device, a signal quality measurement result regarding a downlink signal to a network device; and
receiving, by the terminal device, a target wake-up signal format from the network device, wherein the target wake-up signal format is a wake-up signal format selected by the network device from a plurality of different wake-up signal formats based on the signal quality measurement result, and the different wake-up signal formats correspond to different quantities of repetitive signal transmissions.

According to some embodiments of the present disclosure, an apparatus for selecting a wake-up signal format is provided. The apparatus includes:
a selecting module, configured to select, based on a signal quality measurement result regarding a downlink signal, a target wake-up signal format from a plurality of different wake-up signal formats; wherein the different wake-up signal formats correspond to different quantities of repetitive signal transmissions; and
a waking up module, configured to wake up based on the target wake-up signal format.

According to some embodiments of the present disclosure, an apparatus for selecting a wake-up signal format is provided. The apparatus includes:
a selecting module, configured to select, based on a signal quality measurement result regarding a downlink signal reported by a terminal device, a target wake-up signal format from a plurality of different wake-up signal formats; wherein the different wake-up signal formats correspond to different quantities of repetitive signal transmissions, and the target wake-up signal format is configured to wake up the terminal device; and
a sending module, configured to send the target wake-up signal format to the terminal device.

According to some embodiments of the present disclosure, an apparatus for waking up a terminal device is provided. The apparatus includes:
a sending module, configured to report a signal quality measurement result regarding a downlink signal to a network device; and
a receiving module, configured to receive a target wake-up signal format from the network device, wherein the target wake-up signal format is a wake-up signal format selected by the network device from a plurality of different wake-up signal formats based on the signal quality measurement result, and the different wake-up signal formats correspond to different quantities of repetitive signal transmissions.

According to some embodiments of the present disclosure, a terminal device is provided. The terminal device includes a processor and a memory storing a computer program therein, wherein the processor, when loading and executing the computer program, is caused to perform the above method executed by the terminal device.

According to some embodiments of the present disclosure, a network device is provided. The network device includes a processor and a memory storing a computer program therein, wherein the processor, when loading and executing the computer program, is caused to perform the above method executed by the network device.

According to some embodiments of the present disclosure, a non-transitory computer-readable storage medium storing a computer program therein is provided. The computer program, when loaded and executed by a processor of a device, causes the device to perform the method described above.

According to some embodiments of the present disclosure, a chip including a programmable logic circuit and/or a program instruction is provided. The chip, when running, is caused to perform the method described above.

According to some embodiments of the present disclosure, a computer program product or a computer program is provided. The computer program product or the computer program includes a computer instruction stored in a computer-readable storage medium, wherein a processor, when loading and executing the computer instruction in the computer-readable storage medium, is caused to perform the method described above.

### BRIEF DESCRIPTION OF THE DRAWINGS

FIG. 1 is a schematic diagram of a network architecture according to some embodiments of the present disclosure;

FIG. 2 is a schematic diagram illustrating the wake-up of a primary receiver based on a wake-up signal according to some embodiments of the present disclosure;

FIG. 3 is a flowchart of a method for selecting a wake-up signal format according to some embodiments of the present disclosure;

FIG. 4 is a schematic diagram illustrating different wake-up signal formats corresponding to different quantities of repetitive signal transmissions according to some embodiments of the present disclosure;

FIG. 5 is a schematic diagram illustrating different wake-up signal formats corresponding to different coverage areas according to some embodiments of the present disclosure;

FIG. 6 is a flowchart of a method for selecting a wake-up signal format according to some embodiments of the present disclosure;

FIG. 7 is a flowchart of a method for selecting a wake-up signal format according to some embodiments of the present disclosure;

FIG. 8 is a flowchart of a method for selecting a wake-up signal format according to some embodiments of the present disclosure;

FIG. 9 is a block diagram of an apparatus for selecting a wake-up signal format according to some embodiments of the present disclosure;

FIG. 10 is a block diagram of an apparatus for selecting a wake-up signal format according to some embodiments of the present disclosure;

FIG. 11 is a block diagram of an apparatus for waking up a terminal device according to some embodiments of the present disclosure;

FIG. 12 is a schematic structural diagram of a terminal device according to some embodiments of the present disclosure; and

FIG. 13 is a schematic structural diagram of a network device according to some embodiments of the present disclosure.

### DETAILED DESCRIPTION

For clearer descriptions of the objects, technical solutions, and advantages of the present disclosure, embodiments of the present disclosure are further described in detail hereinafter with reference to the accompanying drawings.

The network architecture and service scenarios described in the embodiments of the present disclosure are intended to more clearly describe the technical solutions in the embodiments of the present disclosure, but do not constitute a limitation on the technical solutions according to the embodiments of the present disclosure. Those of ordinary skill in the art learn that, with the evolution of the network architecture and the emergence of new service scenarios, the technical solutions according to the embodiments of the present disclosure are also applicable to similar technical problems.

The technical solutions according to the embodiments of the present disclosure may be applied to various communication systems, such as a global system of mobile communication (GSM) system, a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), wireless fidelity (WiFi), a 5th-generation (5G) system, or other communication systems.

Generally, conventional communication systems support a limited number of connections and are easy to implement. However, with the development of communication technologies, mobile communication systems will support not only conventional communications, but also, such as device-to-device (D2D) communications, machine-to-machine (M2M) communications, machine type communications (MTCs), vehicle-to-vehicle (V2V) communications, or vehicle-to-everything (V2X) communications, and the embodiments of the present disclosure may also be applied to these communication systems.

The communication systems in the embodiments of the present disclosure may be applied to a carrier aggregation (CA) scenario, may also be applied to a dual connectivity (DC) scenario, and may further be applied to a standalone (SA) network deployment scenario.

The communication systems in the embodiments of the present disclosure may be applied to an unlicensed spectrum, wherein the unlicensed spectrum may also be considered as a shared spectrum; or the communication systems in the embodiments of the present disclosure may also be applied to a licensed spectrum, wherein the licensed spectrum may also be considered as an unshared spectrum.

The embodiments of the present disclosure may be applied to a non-terrestrial networks (NTN) system, and may also be applied to a terrestrial networks (TN) system.

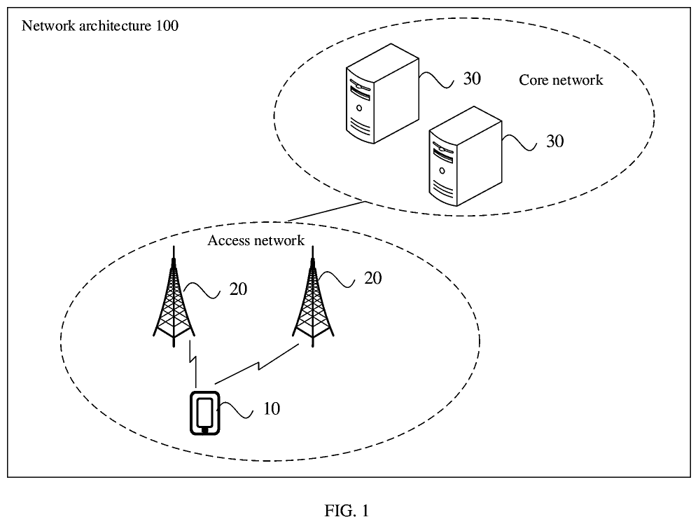

Referring to FIG. 1, a schematic diagram of a network architecture 100 according to some embodiments of the present disclosure is shown. In some embodiments, the network architecture 100 includes: a terminal device 10, an access network device 20, and a core network device 30.

In some embodiments, the terminal device 10 refers to a user equipment (UE), an access terminal, a subscriber unit, a subscriber station, a rover station, a mobile station, a remote station, a remote terminal, a mobile device, a radio communication device, a user agent, or a user device. In some embodiments, the terminal device 10 also refers to a cellular phone, a cordless phone, a session initiation protocol (SIP) phone, a wireless local loop (WLL) station, a personal digital assistant (PDA), a handheld device with a radio communication function, a computing device, or other processing device connected to a wireless modem, a vehicle-mounted device, a wearable device, a terminal device in a 5th generation system (5GS), or a terminal device in a public land mobile network (PLMN) evolved in the future, or the like, which is not limited in the embodiments of the present disclosure. For convenience of description, the devices described above are collectively referred to as the terminal devices. The number of terminal devices 10 is usually plural, and one or more terminal devices 10 are distributed in a cell managed by each access network device 20.

The access network device 20 is a device deployed in an access network to provide a radio communication function for the terminal device 10. In some embodiments, the access network device 20 includes various forms of macro base stations, micro base stations, relay stations, access points, and the like. In systems using different radio access technologies, a device with functionality of an access network device may have different names. For example, the device is referred to as gNodeB or gNB in the 5G NR system. As communication technologies evolve, the name “access network device” may change. For convenience of description, in the embodiments of the present disclosure, the devices providing the radio communication function for the terminal device 10 are collectively referred to as the access network device. In some embodiments, a communication relationship can be established between the terminal device 10 and the core network device 30 through the access network device 20. In some embodiments, in a long term evolution (LTE) system, the access network device 20 refers to an evolved universal terrestrial radio access network (EUTRAN) or one or more eNodeBs in EUTRAN; in a 5G NR system, the access network device 20 refers to a radio access network (RAN) or one or more gNBs in the RAN. In the embodiments of the present disclosure, unless specifically stated otherwise, the “network device” refers to the access network device 20, such as a base station.

The core network device 30 is a device deployed in a core network, and the functions of the core network device 30 are mainly to provide user connections and user management, complete a bearer for a service, and provide an interface to an external network as a bearer network. For example, the core network device in the 5G NR system may include an access and mobility management function (AMF) entity, a user plane function (UPF) entity, a session management function (SMF) entity, and the like.

In some embodiments, the access network device 20 and the core network device 30 communicate with each other through a specific air interface technology, such as an NG interface in a 5G NR system. The access network device 20 and the terminal device 10 communicate with each other through a specific air interface technology, such as a Uu interface.

The “5G NR system” in the embodiments of the present disclosure may also be referred to as a 5G system or an NR system, but those skilled in the art can understand the meaning thereof. The technical solutions described in the embodiments of the present disclosure are applicable to an LTE system, a 5G NR system, a subsequent evolution system of the 5G NR system, or other communication systems such as a narrow band internet of things (NB-IoT) system, which is not limited in the present disclosure.

In some embodiments of the present disclosure, a network device provides a service for a cell, and a terminal device communicates with the network device through a transmission resource (e.g., a frequency domain resource or a frequency spectrum resource) on a carrier used by the cell, wherein the cell is a cell corresponding to the network device (e.g., a base station), and the cell belongs to a macro base station or a base station corresponding to a small cell, wherein the small cell includes: metro cell, micro cell, pico cell, femto cell, and the like, and the small cells have the characteristics of small coverage area and low transmission power, which are suitable for providing high-rate data transmission services.

Before the technical solutions of the present disclosure are detailed, some background technical knowledge involved in the present disclosure is first explained. As an alternative, the following related technologies may be combined with the technical solutions of the embodiments of the present disclosure in any manner, all of which fall within the protection scope of the embodiments of the present disclosure. The embodiments of the present disclosure include at least some of the following.

### 1. 5G NR Paging Mechanism

The main functions of the paging mechanism include two aspects. One aspect is to enable the network device to page the terminal device through a paging message in the case that the terminal device is in an idle state (RRC_IDLE state) or an inactive state (RRC_INACTIVE state). Another aspect is to enable the network device to notify, through a short message, the terminal device of system message change or public warning information such as earthquake or tsunami, and at this time, the paging mechanism is applicable to all radio resource control (RRC) states of the terminal device, including a connected state (RRC_CONNECTED state).

In one example, the paging channel includes a physical downlink control channel (PDCCH) scrambled by a paging radio network temporary identifier (P-RNTI) and a physical downlink share channel (PDSCH) scheduled by the PDCCH. For example, the paging message is transmitted in the PDSCH, and the short message occupies 8 bits and is transmitted in the PDCCH.

For a terminal device in an idle state or an inactive state, as there is no other data communication between the terminal device and a network device, in order to achieve power saving of the terminal device, the terminal device may monitor the paging channel discontinuously, that is, a paging discontinuous reception (DRX) mechanism is adopted. Under the paging DRX mechanism, the terminal device only needs to monitor the paging message during one paging occasion (PO) of each DRX cycle. In the embodiments of the present disclosure, the PO includes a series of monitoring occasions for the PDCCH, and in some embodiments, the PO is composed of a plurality of slots. In addition, in the paging DRX mechanism, there is a concept of the paging frame (PF), wherein PF refers to a radio frame (for example, the radio frame is 10 ms), and in some embodiments, the radio frame includes at least one PO; or the radio frame includes a start position of at least one PO.

In some embodiments, the cycle of the paging DRX is determined by a common cycle in system broadcast and a dedicated cycle configured in high-level signaling (e.g., non-access stratum (NAS) signaling), and in some embodiments, the terminal device takes the minimum cycle of the two cycles as the paging DRX cycle. In some embodiments, a paging DRX cycle includes at least one PO, and which PO the terminal device specifically adopts to monitor is associated with the identifier of the terminal device. The following exemplarily shows a method for determining PF and PO in a paging DRX cycle for a terminal device.

The numbering of the system frame number (SFN) of the PF is determined by the following formula:

$$( SFN + PF\_offset ) mod T = ( T div N ) * ( UE\_ID mod N )$$

where T is a DRX cycle of the terminal device receiving the paging. In one example, the network device broadcasts 1 default DRX cycle, and in the case that the terminal device is configured with its dedicated DRX cycle by the RRC message or the high-level message (e.g., NAS message), the terminal device takes the minimum DRX cycle of the DRX cycle broadcasted by the network device and the DRX cycle configured by the RRC message or the high-level message (e.g., NAS message) as T; and in the case that the terminal device is not configured with its dedicated DRX cycle by the RRC message or the high-level message (e.g., NAS message), the terminal device takes the DRX cycle broadcasted by the network device as T. N is the number of PFs contained in one DRX cycle. Ns is the number of POs contained in one PF. PF_offset is a time-domain offset configured to determine the PF.

The Index (numbering) (i_s) of a PO in one PF is determined by the following formula:

$$i\_s = floor ( UE\_ID / N ) mod Ns$$

where UE_ID is a remainder obtained by dividing the temporary mobile subscriber identity (TMSI) of the terminal device by 1024.

For the terminal device, the position of the PF and the Index of the PO in a paging DRX cycle can be determined based on the above formulas. In one example, a PO is composed of at least one PDCCH monitoring occasion, and one PO contains X PDCCH monitoring occasions, where X is a positive integer and is equal to the number of synchronization signal blocks (SSBs) actually transmitted in a system message. Upon determining the position of the PF, the Index of the PO, and the number of PDCCH monitoring occasions in the PO, the terminal device can determine the initial position of the first PDCCH monitoring occasion in the PO only by using the relevant configuration parameters, wherein the initial position may be configured through high-level signaling or obtained based on the Index of the PO. Upon determining the initial position, the terminal device can blindly detect the paging message based on the determined PO.

### 2. Paging False Alarm

As can be seen from the above determination of the PO by the terminal device, the determination of the PO is associated with UE_ID and the total numbers of PFs and POs. In the case that there is a large number of terminal devices in the system, and a network device cannot allocate each of the terminal devices to a different PO, a plurality of terminal devices may correspond to one PO. In the case that the network device needs to page a specific terminal device on this PO, it may cause other terminal devices that do not have paging messages to perform extra blind detection, which mainly include blind detection of the PDCCH and the corresponding PDSCH. For those terminal devices that do not have paging messages, this false paging is a paging false alarm.

In the work item of R17, the 3GPP RAN has agreed, by all of the members, with a further enhancement project (RP-193239) about power saving for terminals. One goal of the project is to reduce unnecessary paging reception (i.e., reduction of paging false alarms) by designing an enhanced paging mechanism.

Based on the current standardization progress of the R17 UE power saving project, it has been agreed to introduce the following mechanisms to reduce paging false alarms.
1) The paging early indication (PEI) designed based on the PDCCH is introduced, that is, the network device sends the PEI before a PO, and the terminal device determines whether to normally monitor paging on the corresponding PO or skip paging monitoring based on the received PEI.
2) A paging mechanism based on grouping of terminal devices is introduced, that is, a plurality of terminal devices allocated to a same PO are further grouped, the network device may indicate to which terminal device or which group of terminal devices the paging message is directed, and then terminal devices in other terminal device groups do not need to receive paging messages anymore. In some embodiments, the paging group indication information is carried in the PEI.

### 3. Ultra-Low Power Wake-Up Signal (LP-WUS)

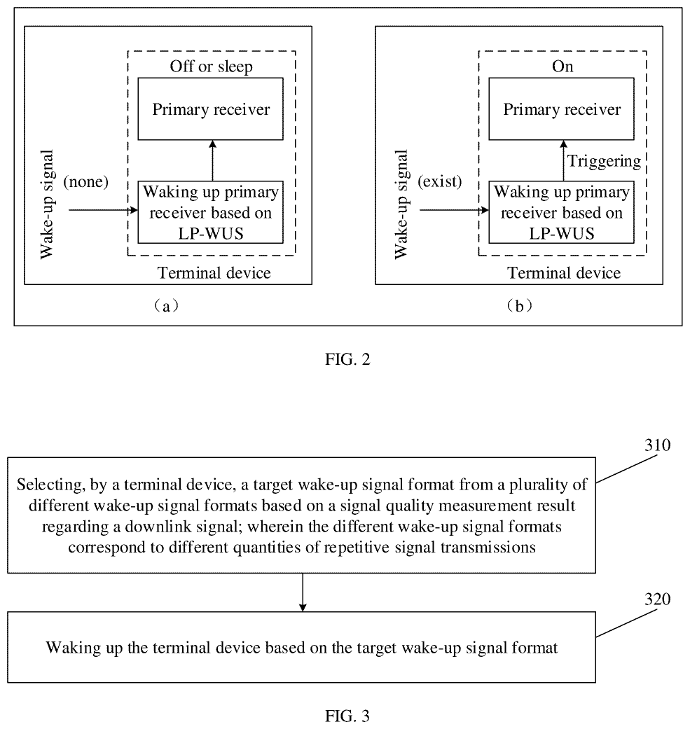

Compared with the PEI mechanism of R17, LP-WUS is more power-efficient, with a lower power receiver used, i.e., the primary receiver is not used. As shown in FIG. 2, the terminal device is provided with a primary receiver and a secondary receiver, with the power consumption of the secondary receiver being lower than the power consumption of the primary receiver. In the low power consumption state, the primary receiver is in an off or sleep state, and the secondary receiver is in an on state. Upon receiving a wake-up signal (e.g., LP-WUS) through the secondary receiver, the terminal device starts the primary receiver to monitor the paging message, so as to achieve the purpose of energy saving. In some examples, the LP-WUS can be used in an RRC_CONNECTED state in addition to the RRC_IDLE/RRC_INACTIVE states.

Based on the performance evaluation of the LP-WUS, although the power consumption of the terminal device can be saved by introducing the LP-WUS receiver, the sensitivity performance of the LP-WUS receiver is reduced relative to the PEI of R17, and the coverage area supported by the signal is correspondingly reduced, as shown in Table 1 below. From the perspective of standardization, it is necessary to research how to improve the coverage performance of LP-WUS.

TABLE 1
LP-WUS performance comparison graph

| Solution | Coverage area | Sensitivity | | Power consumption | | | Signal |
|---|---|---|---|---|---|---|---|
| R15 IDLE | >500 m | ~−100 | dBm | 1X | | | No WUS |
| R17 PEI for IDLE | >500 m | ~−100 | dBm | 30-50 | mW | 0.8~0.9X | R17 PEI-PDCCH based, or (SSS/ |
| | | | | | | | TRS-like) sequence based |
| AZP WUR | 100 m~200 m | −70-−90 | dBm | <100 | uW | 0.001~0.01X | New signals, OOK waveform based |

Referring to FIG. 3, a flowchart of a method for selecting a wake-up signal format according to embodiments of the present disclosure is shown. The method can be applied to the network architecture shown in FIG. 1. In some embodiments, the method includes at least one of the following steps (310-320).

In S310, a terminal device selects, based on a signal quality measurement result regarding a downlink signal, a target wake-up signal format from a plurality of different wake-up signal formats; wherein the different wake-up signal formats correspond to different quantities of repetitive signal transmissions.

In the embodiments of the present disclosure, the wake-up signal is a signal for waking up the terminal device. In some embodiments, the wake-up signal is sent by the network device to the terminal device to trigger the terminal device to switch from one state/mode to another state/mode. In some embodiments, the wake-up signal is a low power wake-up signal (such as the LP-WUS introduced above), which is configured to trigger the terminal device to switch from a low power mode to a non-low power mode.

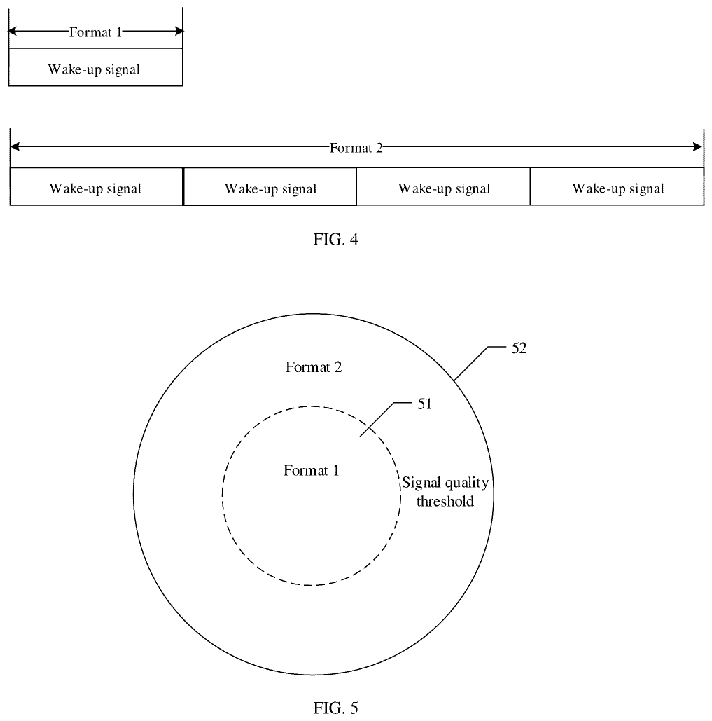

In the embodiments of the present disclosure, the wake-up signal format is equivalent to a wake-up signal, and is described as wake-up signal format only for distinguishing different formats. The wake-up signal has a plurality of formats, and different wake-up signal formats correspond to different quantities of repetitive signal transmissions, such that different wake-up signal formats have different signal coverage areas. In some embodiments, as shown in FIG. 4, the wake-up signal includes two different formats, i.e., format 1 and format 2, wherein the quantity of repetitive signal transmissions corresponding to format 1 is 1, and the quantity of repetitive signal transmissions corresponding to format 2 is 4.

In some embodiments, the quantity of repetitive signal transmissions corresponding to the wake-up signal format is in a positive correlation with the signal coverage area corresponding to the wake-up signal format. That is, the larger the quantity of repetitive signal transmissions corresponding to a specific wake-up signal format is, the larger the signal coverage area corresponding to the wake-up signal format is; conversely, the smaller the quantity of repetitive signal transmissions corresponding to a specific wake-up signal format is, the smaller the signal coverage area corresponding to the wake-up signal format is. In some embodiments, as shown in FIG. 5, still taking the example that the quantity of repetitive signal transmissions corresponding to format 1 is 1 and the quantity of repetitive signal transmissions corresponding to format 2 is 4, because the quantity of repetitive signal transmissions corresponding to format 2 is greater than the quantity of repetitive signal transmissions corresponding to format 1, the signal coverage area 52 (the area indicated by the solid-line circle in the figure) corresponding to format 2 is greater than the signal coverage area 51 (the area indicated by the dashed-line circle in the figure) corresponding to format 1.

In the embodiments of the present disclosure, a target wake-up signal format is selected, based on a signal quality measurement result measured by the terminal device regarding a downlink signal, from a plurality of different wake-up signal formats. The downlink signal refers to a signal sent by the network device to the terminal device, and in the embodiments of the present disclosure, the specific form of the downlink signal is not limited. In some embodiments, the terminal device measures the quality of the downlink signal to acquire the signal quality measurement result regarding the downlink signal. In some embodiments, the signal quality measurement result includes a measurement result corresponding to one measurement quantity, or includes measurement results corresponding to a plurality of measurement quantities. In some embodiments, the signal quality measurement result includes a measurement result corresponding to at least one of the following measurement quantities: reference signal receiving power (RSRP), reference signal receiving quality (RSRQ), or signal to interference plus noise ratio (SINR). In addition, the above description of the measurement quantity is only exemplary and explanatory, and other measurement quantities that can characterize the signal quality also can be used, which is not limited in the present disclosure.

In some embodiments, the signal quality characterized by the signal quality measurement result is in a negative correlation with the quantity of repetitive signal transmissions corresponding to the target wake-up signal format. That is, the higher the signal quality characterized by the signal quality measurement result is, a wake-up signal format corresponding to a smaller quantity of repetitive signal transmissions is selected as the target wake-up signal format; conversely, the lower the signal quality characterized by the signal quality measurement result is, a wake-up signal format corresponding to a larger quantity of repetitive signal transmissions is selected as the target wake-up signal format.

In some embodiments, the terminal device determines, based on signal quality ranges respectively corresponding to the plurality of different wake-up signal formats, a wake-up signal format corresponding to a target signal quality range to which the signal quality measurement result belongs as the target wake-up signal format. In some embodiments, format 1 corresponds to signal quality range 1, format 2 corresponds to signal quality range 2, and assuming that the signal quality measurement result belongs to signal quality range 1, format 1 is determined as the target wake-up signal format.

In some embodiments, the wake-up signal includes N different formats, where N is an integer greater than 1, and based on N−1 signal quality thresholds, signal quality ranges respectively corresponding to the N different wake-up signal formats are determined. In some embodiments, in the case that the wake-up signal includes three different formats, denoted as format 1, format 2, and format 3, signal quality ranges respectively corresponding to the three formats are determined based on two signal quality thresholds. In some embodiments, the two signal quality thresholds include a threshold value a and a threshold value b, where the threshold value a is greater than the threshold value b; in some embodiments, the signal quality range corresponding to format 1 is a range greater than or equal to the threshold value a, the signal quality range corresponding to format 2 is a range greater than or equal to the threshold value b and less than the threshold value a, and the signal quality range corresponding to format 3 is a range less than the threshold value b.

In some embodiments, the target wake-up signal format is any one of the above wake-up signal formats, and the process of determining the target wake-up signal format by the terminal device includes the following steps:
1. the terminal device acquires a first sequence by sorting the N different wake-up signal formats according to the sequence of the corresponding quantities of repetitive signal transmissions from small to large;
2. the terminal device acquires a second sequence by sorting the N−1 signal quality thresholds from large to small;
3. the terminal device compares the signal quality measurement result with the signal quality thresholds in the second sequence one by one in sequence from a first signal quality threshold in the second sequence;
4. in the case that the signal quality measurement result is determined to be greater than or equal to the i^{th} signal quality threshold in the second sequence, the terminal device determines the i^{th} wake-up signal format in the first sequence as a target wake-up signal format, where i is a positive integer less than or equal to N−1; and
5. in the case that the signal quality measurement result is less than an (N−1)^{th} signal quality threshold in the second sequence, the terminal device determines an N^{th} wake-up signal format in the first sequence as the target wake-up signal format.

In some embodiments, the wake-up signal includes three different formats, denoted as format 1, format 2, and format 3, wherein the quantity of repetitive signal transmissions corresponding to format 1 is 1, the quantity of repetitive signal transmissions corresponding to format 2 is 4, and the quantity of repetitive signal transmissions corresponding to format 3 is 8. In the case that the different formats are sorted according to the sequence of corresponding quantities of repetitive signal transmissions from small to large, the acquired first sequence is: format 1, format 2, format 3. In addition, the two signal quality thresholds include a threshold value a and a threshold value b, wherein the threshold value a is greater than the threshold value b. In the case that the signal quality thresholds are sorted from large to small, the acquired second sequence is: threshold value a, threshold value b. In the case that the signal quality measurement result of the terminal device regarding the downlink signal in the serving cell is greater than (or equal to) the threshold value a, format 1 is selected as a target wake-up signal format; otherwise, in the case that the signal quality measurement result of the terminal device regarding the downlink signal in the serving cell is greater than (or equal to) the threshold value b, format 2 is selected as the target wake-up signal format; otherwise, format 3 is selected as the target wake-up signal format. The above method for selecting the target wake-up signal format can ensure that the frequency of sending wake-up signals by the network device is reduced as much as possible on the premise of meeting the requirement of the coverage area of the wake-up signal (i.e., on the premise of ensuring the receiving success rate of the wake-up signals), thereby reducing the processing overhead of the network device and saving the transmission resources.

In some embodiments, in the case that the signal quality range corresponding to the target wake-up signal format includes value ranges respectively corresponding to M measurement quantities, where M is an integer greater than 1, the signal quality measurement result includes measurement results respectively corresponding to the M measurement quantities, and the measurement result corresponding to each measurement quantity meets the value range corresponding to the measurement quantity. That is, in the case that a specific wake-up signal format corresponds to value ranges respectively corresponding to a plurality of measurement quantities, the wake-up signal format is selected only in the case of the measurement results respectively corresponding to all the measurement quantities meeting the corresponding value ranges. This method has strict requirements on signal quality, and can ensure the success rate of waking up the terminal device based on the selected target wake-up signal format as much as possible.

In another example, in the case that the signal quality range corresponding to the target wake-up signal format includes value ranges respectively corresponding to M measurement quantities, where M is an integer greater than 1, the signal quality measurement result includes a measurement result corresponding to at least one measurement quantity, and there is a measurement result corresponding to at least one measurement quantity that meets the value range corresponding to the measurement quantity. That is, in the case that a specific wake-up signal format corresponds to the value ranges respectively corresponding to a plurality of measurement quantities, the wake-up signal format is selected only needs a determination that the measurement results corresponding to some of the measurement quantities meet the corresponding value ranges. This method has less strict requirements on signal quality relative to the previous method, but is beneficial to reducing the frequency of sending wake-up signals by the network device, thereby reducing the processing overhead of the network device and saving the transmission resources.

In S320, the terminal device is woken up based on the target wake-up signal format.

In the case that the target wake-up signal format is selected by the terminal device, the terminal device is woken up based on the target wake-up signal format. In some embodiments, the terminal device is woken up upon receiving the target wake-up signal format. In some embodiments, taking the example that the target wake-up signal format is a low power wake-up signal (such as the LP-WUS introduced above), the terminal device switches from the low power mode to the non-low power mode upon receiving the target wake-up signal format.

In summary, according to the technical solutions provided in the embodiments of the present disclosure, a plurality of different wake-up signal formats are set for different coverage areas in a cell, a target wake-up signal format suitable for a terminal device is selected from the plurality of different wake-up signal formats based on a signal quality measurement result of the terminal device regarding a downlink signal, and subsequently, a network device wakes up the terminal device by using the target wake-up signal format, such that wake-up signals sent by the network device can be ensured to reach the terminal device as much as possible, thereby improving the reception reliability of the wake-up signals.

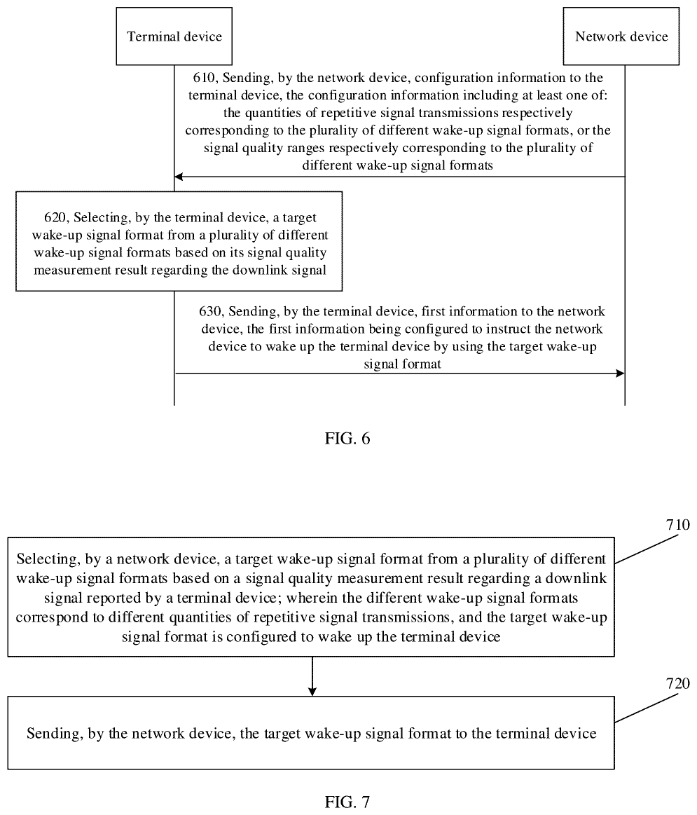

Referring to FIG. 6, a flowchart of a method for selecting a wake-up signal format according to some embodiments of the present disclosure is shown. The method can be applied to the network architecture shown in FIG. 1. In some embodiments, the method includes at least one of the following steps (610-630).

In S610, the network device sends configuration information to the terminal device, the configuration information including at least one of: quantities of repetitive signal transmissions respectively corresponding to a plurality of different wake-up signal formats, and signal quality ranges respectively corresponding to the plurality of different wake-up signal formats.

Accordingly, the terminal device receives the configuration information from the network device.

In some embodiments, different wake-up signal formats correspond to different quantities of repetitive signal transmissions.

In some embodiments, in an aspect, the network device configures N wake-up signal formats and the quantities of repetitive signal transmissions respectively corresponding to the N wake-up signal formats, and the network device notifies the terminal device of the N wake-up signal formats and the quantities of repetitive signal transmissions respectively corresponding to the N wake-up signal formats through the configuration information. In another aspect, the network device further configures signal quality ranges respectively corresponding to the N wake-up signal formats, and the network device further notifies the terminal device of the signal quality ranges respectively corresponding to the N wake-up signal formats through the configuration information, such that the terminal device performs format selection based on the signal quality ranges.

In some embodiments, in the case that the network device acquires the signal quality ranges respectively corresponding to the N wake-up signal formats by dividing using N−1 signal quality thresholds, the network device further notifies the terminal device of the N−1 signal quality thresholds through the configuration information, which is equivalent to notifying the terminal device of the signal quality ranges respectively corresponding to the N wake-up signal formats.

In some embodiments, the signal quality range corresponding to any one of the wake-up signal formats includes value ranges respectively corresponding to one or more measurement quantities. The one or more measurement quantities include, but are not limited to, at least one of RSRP, RSRQ, or SINR.

In some embodiments, the quantity of repetitive signal transmissions corresponding to the wake-up signal format is in a negative correlation with the signal quality threshold corresponding to the wake-up signal format. That is, the smaller the quantity of repetitive signal transmissions corresponding to the wake-up signal format is, the higher the signal quality threshold corresponding to the wake-up signal format is; conversely, the larger quantity of repetitive signal transmissions corresponding to the wake-up signal format is, the lower the signal quality threshold corresponding to the wake-up signal format is.

In S620, the terminal device selects, based on its signal quality measurement result regarding the downlink signal, a target wake-up signal format from a plurality of different wake-up signal formats.

In some embodiments, the terminal device determines, based on the signal quality ranges respectively corresponding to the plurality of wake-up signal formats, a wake-up signal format corresponding to a target signal quality range to which the signal quality measurement result belongs as the target wake-up signal format. For details about the selection process of the target wake-up signal format, reference is made to the description in the above embodiments, which are not described herein any further.

In S630, the terminal device sends first information to the network device, the first information being configured to instruct the network device to wake up the terminal device by using the target wake-up signal format.

Accordingly, the network device receives the first information from the terminal device.

Upon the target wake-up signal format being selected, the terminal device needs to notify the network device of the target wake-up signal format, such that the network device subsequently sends a wake-up signal to the terminal device according to the target wake-up signal format. In some embodiments, the first information includes identification information of the target wake-up signal format. In some embodiments, the first information is sent through RRC signaling, MAC control element (MAC CE) signaling, or in other forms, which is not limited in the present disclosure.

According to the embodiments of the present disclosure, the terminal device is configured with a plurality of wake-up signal formats by the network device, and the relevant configuration information of the plurality of wake-up signal formats is sent to the terminal device, such that the terminal device can select, based on the configuration information combining its signal quality measurement result regarding the downlink signal, a wake-up signal format suitable for itself, and notify the network device of the selected format. In this way, the wake-up signals sent by the network device can be ensured to reach the terminal device as much as possible, thereby improving the reception reliability of the wake-up signals.

Referring to FIG. 7, a flowchart of a method for selecting a wake-up signal format according to some embodiments of the present disclosure is shown. The method can be applied to the network architecture shown in FIG. 1. In some embodiments, the method includes at least one of the following steps (710-720).

In S710, a network device selects, based on a signal quality measurement result regarding a downlink signal reported by a terminal device, a target wake-up signal format from a plurality of different wake-up signal formats; wherein the different wake-up signal formats correspond to different quantities of repetitive signal transmissions, and the target wake-up signal format is configured to wake up the terminal device.

In the embodiments of the present disclosure, the wake-up signal is a signal for waking up the terminal device. In some embodiments, the wake-up signal is sent by the network device to the terminal device to trigger the terminal device to switch from one state/mode to another state/mode. In some embodiments, the wake-up signal is a low power wake-up signal (such as the LP-WUS introduced above), which is configured to trigger the terminal device to switch from a low power mode to a non-low power mode.

In the embodiments of the present disclosure, the wake-up signal format is equivalent to the wake-up signal, and is described as wake-up signal format only for distinguishing different formats. The wake-up signal has a plurality of formats, and different wake-up signal formats correspond to different quantities of repetitive signal transmissions, such that different wake-up signal formats have different signal coverage areas. In some embodiments, as shown in FIG. 4, the wake-up signal includes two different formats, i.e., format 1 and format 2, wherein the quantity of repetitive signal transmissions corresponding to format 1 is 1, and the quantity of repetitive signal transmissions corresponding to format 2 is 4.

In some embodiments, the quantity of repetitive signal transmissions corresponding to the wake-up signal format is in a positive correlation with the signal coverage area corresponding to the wake-up signal format. That is, the larger the quantity of repetitive signal transmissions corresponding to a specific wake-up signal format is, the larger the signal coverage area corresponding to the wake-up signal format is; conversely, the smaller the quantity of repetitive signal transmissions corresponding to a specific wake-up signal format is, the smaller the signal coverage area corresponding to the wake-up signal format is. In some embodiments, as shown in FIG. 5, still taking the example that the quantity of repetitive signal transmissions corresponding to format 1 is 1 and the quantity of repetitive signal transmissions corresponding to format 2 is 4, because the quantity of repetitive signal transmissions corresponding to format 2 is greater than the quantity of repetitive signal transmissions corresponding to format 1, the signal coverage area 52 (the area indicated by the solid-line circle in the figure) corresponding to format 2 is greater than the signal coverage area 51 (the area indicated by the dashed-line circle in the figure) corresponding to format 1.

In the embodiments of the present disclosure, a target wake-up signal format is selected, based on a signal quality measurement result of the terminal device regarding a downlink signal, from a plurality of different wake-up signal formats. The downlink signal refers to a signal sent by the network device to the terminal device, and in the embodiments of the present disclosure, the specific form of the downlink signal is not limited. In some embodiments, the terminal device acquires a signal quality measurement result regarding the downlink signal by measuring the quality of the downlink signal. In some embodiments, the signal quality measurement result includes a measurement result corresponding to one measurement quantity, or includes measurement results respectively corresponding to a plurality of measurement quantities. In some embodiments, the signal quality measurement result includes a measurement result corresponding to at least one of the following measurement quantities: reference signal receiving power (RSRP), reference signal receiving quality (RSRQ), or signal to interference plus noise ratio (SINR). In addition, the above description of the measurement quantity is only exemplary and explanatory, and other measurement quantities that can characterize the signal quality can also be used, which is not limited in the present disclosure.

In some embodiments, the signal quality characterized by the signal quality measurement result is in a negative correlation with the quantity of repetitive signal transmissions corresponding to the target wake-up signal format. That is, the higher the signal quality characterized by the signal quality measurement result is, a wake-up signal format corresponding to a smaller quantity of repetitive signal transmissions is selected as the target wake-up signal format; conversely, the lower the signal quality characterized by the signal quality measurement result is, a wake-up signal format corresponding to a larger quantity of repetitive signal transmissions is selected as the target wake-up signal format.

In some embodiments, the network device determines, based on signal quality ranges respectively corresponding to the plurality of different wake-up signal formats, a wake-up signal format corresponding to a target signal quality range to which the signal quality measurement result belongs as the target wake-up signal format. In some embodiments, format 1 corresponds to signal quality range 1, format 2 corresponds to signal quality range 2, and assuming that the signal quality measurement result belongs to signal quality range 1, format 1 is determined as the target wake-up signal format.

In some embodiments, the wake-up signal includes N different formats, where N is an integer greater than 1, and based on N−1 signal quality thresholds, signal quality ranges respectively corresponding to the N different wake-up signal formats are determined. In some embodiments, in the case that the wake-up signal includes three different formats, denoted as format 1, format 2, and format 3, signal quality ranges respectively corresponding to the three formats are determined based on two signal quality thresholds. In some embodiments, the above two signal quality thresholds include a threshold value a and a threshold value b, where the threshold value a is greater than the threshold value b; in some embodiments, the signal quality range corresponding to format 1 is a range greater than or equal to the threshold value a, the signal quality range corresponding to format 2 is a range greater than or equal to the threshold value b and less than the threshold value a, and the signal quality range corresponding to format 3 is a range less than the threshold value b.

In some embodiments, the target wake-up signal format is any one of the above wake-up signal formats, and the process of determining the target wake-up signal format by the network device includes the following steps:
1. the network device acquires a first sequence by sorting the N different wake-up signal formats according to the sequence of the corresponding quantities of repetitive signal transmissions from small to large;
2. the network device acquires a second sequence by sorting the N−1 signal quality thresholds from large to small;
3. the network device compares the signal quality measurement result with the signal quality thresholds in the second sequence one by one in sequence from a first signal quality threshold in the second sequence;
4. in the case that the signal quality measurement result is determined to be greater than or equal to the i^{th} signal quality threshold in the second sequence, the network device determines the i^{th} wake-up signal format in the first sequence as a target wake-up signal format, where i is a positive integer less than or equal to N−1; and
5. in the case that the signal quality measurement result is less than an (N−1)^{th} signal quality threshold in the second sequence, the network device determines an N^{th} wake-up signal format in the first sequence as the target wake-up signal format.

In some embodiments, the wake-up signal includes three different formats, denoted as format 1, format 2, and format 3, wherein the quantity of repetitive signal transmissions corresponding to format 1 is 1, the quantity of repetitive signal transmissions corresponding to format 2 is 4, and the quantity of repetitive signal transmissions corresponding to format 3 is 8. In the case that the different formats are sorted according to the sequence of the corresponding quantities of repetitive signal transmissions from small to large, the acquired first sequence is: format 1, format 2, format 3. In addition, the two signal quality thresholds include a threshold value a and a threshold value b, wherein the threshold value a is greater than the threshold value b. In the case that the signal quality thresholds are sorted from large to small, the acquired second sequence is: threshold value a, threshold value b. In the case that the signal quality measurement result of the terminal device regarding the downlink signal in the serving cell is greater than (or equal to) the threshold value a, format 1 is selected as a target wake-up signal format; otherwise, in the case that the signal quality measurement result of the terminal device regarding the downlink signal in the serving cell is greater than (or equal to) the threshold value b, format 2 is selected as the target wake-up signal format; otherwise, format 3 is selected as the target wake-up signal format. The above method for selecting the target wake-up signal format can ensure that the frequency of sending wake-up signals by the network device is reduced as much as possible on the premise of meeting the requirement of the coverage area of the wake-up signal (i.e., on the premise of ensuring the receiving success rate of the wake-up signals), thereby reducing the processing overhead of the network device and saving the transmission resources.

In some embodiments, in the case that the signal quality range corresponding to the target wake-up signal format includes value ranges respectively corresponding to M measurement quantities, where M is an integer greater than 1, the signal quality measurement result includes measurement results respectively corresponding to the M measurement quantities, and the measurement result corresponding to each measurement quantity meets the value range corresponding to the measurement quantity. That is, in the case that a specific wake-up signal format corresponds to the value ranges respectively corresponding to a plurality of measurement quantities, the wake-up signal format is selected only in the case of the measurement results respectively corresponding to all the measurement quantities meeting the corresponding value ranges. This method has strict requirements on signal quality, and can ensure the success rate of waking up the terminal device based on the selected target wake-up signal format as much as possible.

In some embodiments, in the case that the signal quality range corresponding to the target wake-up signal format includes value ranges respectively corresponding to M measurement quantities, where M is an integer greater than 1, the signal quality measurement result includes a measurement result corresponding to at least one measurement quantity, and there is a measurement result corresponding to at least one measurement quantity that meets the value range corresponding to the measurement quantity. That is, in the case that a specific wake-up signal format corresponds to the value ranges respectively corresponding to a plurality of measurement quantities, the wake-up signal format is selected only needs a determination that the measurement results corresponding to some of the measurement quantities meet the corresponding value ranges. This method has less strict requirements on signal quality relative to the previous method, but is beneficial to reducing the frequency of sending wake-up signals by the network device, thereby reducing the processing overhead of the network device and saving the transmission resources.

In S720, the network device sends the target wake-up signal format to the terminal device.

Upon the target wake-up signal format being selected, the network device wakes up the terminal device by using the target wake-up signal format. In some embodiments, the network device sends the target wake-up signal format to the terminal device. In some embodiments, taking the example that the target wake-up signal format is a low power wake-up signal (such as the LP-WUS introduced above), the terminal device switches from the low power mode to the non-low power mode upon receiving the target wake-up signal format.

In summary, according to the technical solutions provided in the embodiments of the present disclosure, a plurality of different wake-up signal formats are set for different coverage areas in a cell, a target wake-up signal format suitable for a terminal device is selected, based on a signal quality measurement result of the terminal device regarding a downlink signal, from the plurality of different wake-up signal formats, and subsequently, a network device wakes up the terminal device by using the target wake-up signal format, such that wake-up signals sent by the network device can be ensured to reach the terminal device as much as possible, thereby improving the reception reliability of the wake-up signals.

In the embodiments shown in FIG. 3, the target wake-up signal format is selected by the terminal device from the plurality of different wake-up signal formats, and in the embodiments shown in FIG. 7, the target wake-up signal format is selected by the network device from the plurality of different wake-up signal formats. In practical applications, different embodiments may be selected according to actual situations, which is not limited in the present disclosure.

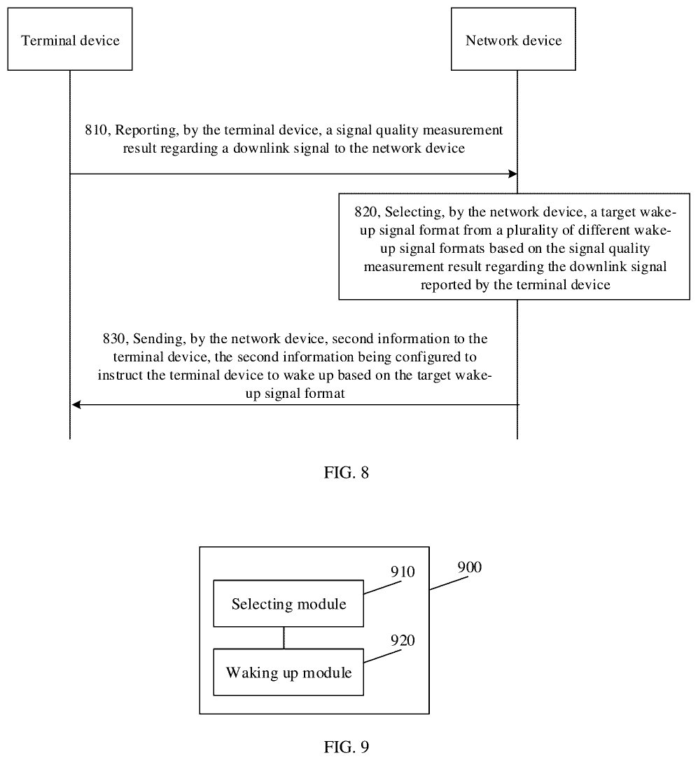

Referring to FIG. 8, a flowchart of a method for selecting a wake-up signal format according to some embodiments of the present disclosure is shown. The method can be applied to the network architecture shown in FIG. 1. In some embodiments, the method includes at least one of the following steps (810-830).

In S810, a terminal device reports a signal quality measurement result regarding a downlink signal to a network device.

Accordingly, the network device receives the signal quality measurement result from the terminal device.

In some embodiments, the signal quality measurement result includes a measurement result corresponding to at least one of the following measurement quantities: RSRP, RSRQ, and SINR.

In S820, the network device selects, based on the signal quality measurement result regarding the downlink signal reported by the terminal device, a target wake-up signal format from a plurality of different wake-up signal formats.

In some embodiments, different wake-up signal formats correspond to different quantities of repetitive signal transmissions.

In some embodiments, the network device determines, based on the signal quality ranges respectively corresponding to the plurality of wake-up signal formats, a wake-up signal format corresponding to a target signal quality range to which the signal quality measurement result belongs as the target wake-up signal format. For details about the selection process of the target wake-up signal format, reference is made to the description in the above embodiments, which are not described herein any further.

In S830, the network device sends second information to the terminal device, the second information being configured to instruct the terminal device to wake up based on the target wake-up signal format.

Accordingly, the terminal device receives the second information from the network device.

Upon a target wake-up signal format suitable for the terminal device being selected, the network device will subsequently send a wake-up signal to the terminal device based on the target wake-up signal format. Therefore, the network device needs to notify the terminal device of the selected target wake-up signal format, such that the terminal device can also receive the wake-up signal from the network device based on the target wake-up signal format.

In some embodiments, the second information is sent in a form of UE-specific signaling (e.g., RRC signaling, MAC CE signaling, or PDCCH signaling), which is not limited in the embodiments of the present disclosure.

According to the embodiments of the present disclosure, the terminal device provides its signal quality measurement result regarding the downlink signal for the network device, and the network device selects, based on the signal quality measurement result of the terminal device, the target wake-up signal format suitable for the terminal device from a plurality of wake-up signal formats, such that the wake-up signals sent by the network device can be ensured to reach the terminal device as much as possible, thereby improving the reception reliability of the wake-up signals.

It should be noted that the steps executed by the terminal device can be implemented as a method of the terminal device side alone; the steps executed by the network device can be implemented as a method of the network device side alone. In addition, the embodiments provided in the present disclosure can be combined arbitrarily, and for details that are not described in detail in one embodiment, reference can be made to the description of relevant contents in some embodiments.

The following is an apparatus embodiment of the present disclosure that can be configured to implement the method embodiments of the present disclosure. For details that are not disclosed in the apparatus embodiment of the present disclosure, reference is made to the method embodiments of the present disclosure.

Referring to FIG. 9, a block diagram of an apparatus for selecting a wake-up signal format according to embodiments of the present disclosure is shown. The apparatus has the function of implementing the above method for selecting the wake-up signal format on the terminal device side, and the function can be achieved by hardware or by hardware executing corresponding software. In some embodiments, the apparatus is the terminal device described above, or the apparatus is provided in the terminal device. As shown in FIG. 9, in some embodiments, the apparatus 900 includes: a selecting module 910 and a waking up module 920.

The selecting module 910 is configured to select, based on a signal quality measurement result regarding a downlink signal, a target wake-up signal format from a plurality of different wake-up signal formats; wherein the different wake-up signal formats correspond to different quantities of repetitive signal transmissions.

The waking up module 920 is configured to wake up based on the target wake-up signal format.

In some embodiments, the quantity of repetitive signal transmissions corresponding to the wake-up signal format is in a positive correlation with the signal coverage area corresponding to the wake-up signal format.

In some embodiments, the signal quality characterized by the signal quality measurement result is in a negative correlation with the quantity of repetitive signal transmissions corresponding to the target wake-up signal format.

In some embodiments, the selecting module 910 is configured to determine, based on signal quality ranges respectively corresponding to the plurality of different wake-up signal formats, a wake-up signal format corresponding to a target signal quality range to which the signal quality measurement result belongs as the target wake-up signal format.

In some embodiments, signal quality ranges respectively corresponding to N different wake-up signal formats are determined based on N−1 signal quality thresholds, where N is an integer greater than 1; and
the selecting module 910 is configured to:
acquire a first sequence by sorting the N different wake-up signal formats according to the sequence of the corresponding quantities of repetitive signal transmissions from small to large;
acquire a second sequence by sorting the N−1 signal quality thresholds from large to small;
compare the signal quality measurement result with the signal quality thresholds in the second sequence one by one in sequence from a first signal quality threshold in the second sequence;
determine, in the case that the signal quality measurement result is determined to be greater than or equal to an i^{th} signal quality threshold in the second sequence, an i^{th} wake-up signal format in the first sequence as the target wake-up signal format, where i is a positive integer less than or equal to N−1; and
determine, in the case that the signal quality measurement result is less than an (N−1)^{th} signal quality threshold in the second sequence, an N^{th} wake-up signal format in the first sequence as the target wake-up signal format.

In some embodiments, the signal quality range corresponding to the target wake-up signal format includes value ranges respectively corresponding to M measurement quantities, where M is an integer greater than 1; and
the signal quality measurement result includes measurement results respectively corresponding to the M measurement quantities, and the measurement result corresponding to each measurement quantity meets the value range corresponding to the measurement quantity;
or,
the signal quality measurement result includes a measurement result corresponding to at least one measurement quantity, and there is a measurement result corresponding to at least one measurement quantity that meets the value range corresponding to the measurement quantity.

In some embodiments, the apparatus 900 further includes a sending module (not shown in FIG. 9) which is configured to send first information to the network device, the first information being configured to instruct the network device to wake up the terminal device by using the target wake-up signal format.

In some embodiments, the apparatus 900 further includes a receiving module (not shown in FIG. 9) which is configured to receive configuration information from the network device; wherein the configuration information includes at least one of: the quantities of repetitive signal transmissions respectively corresponding to the plurality of different wake-up signal formats, or the signal quality ranges respectively corresponding to the plurality of different wake-up signal formats.

In some embodiments, the wake-up signal format corresponds to a low power wake-up signal, and the target wake-up signal format is configured to trigger the terminal device to switch from a low power mode to a non-low power mode.

In some embodiments, the signal quality measurement result includes a measurement result corresponding to at least one of the following measurement quantities: RSRP, RSRQ, or SINR.

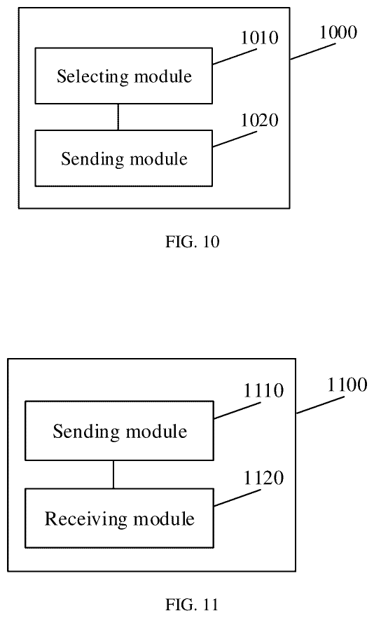

Referring to FIG. 10, a block diagram of an apparatus for selecting a wake-up signal format according to some embodiments of the present disclosure is shown. The apparatus has the function of implementing the above method for selecting the wake-up signal format on the network device side, and the function can be achieved by hardware or by hardware executing corresponding software. In some embodiments, the apparatus is the network device described above or is arranged in the network device. As shown in FIG. 10, in some embodiments, the apparatus 1000 includes: a selecting module 1010 and a sending module 1020.

The selecting module 1010 is configured to select, based on a signal quality measurement result regarding a downlink signal reported by a terminal device, a target wake-up signal format from a plurality of different wake-up signal formats; wherein the different wake-up signal formats correspond to different quantities of repetitive signal transmissions, and the target wake-up signal format is configured to wake up the terminal device.

The sending module 1020 is configured to send the target wake-up signal format to the terminal device.

In some embodiments, the quantity of repetitive signal transmissions corresponding to the wake-up signal format is in a positive correlation with the signal coverage area corresponding to the wake-up signal format.

In some embodiments, the signal quality characterized by the signal quality measurement result is in a negative correlation with the quantity of repetitive signal transmissions corresponding to the target wake-up signal format.

In some embodiments, the selecting module 1010 is configured to determine, based on signal quality ranges respectively corresponding to the plurality of different wake-up signal formats, a wake-up signal format corresponding to a target signal quality range to which the signal quality measurement result belongs as the target wake-up signal format.

In some embodiments, signal quality ranges respectively corresponding to N different wake-up signal formats are determined based on N−1 signal quality thresholds, where N is an integer greater than 1; and
the selecting module 1010 is configured to:
acquire a first sequence by sorting the N different wake-up signal formats according to the sequence of the corresponding quantities of repetitive signal transmissions from small to large;
acquire a second sequence by sorting the N−1 signal quality thresholds from large to small;
compare the signal quality measurement result with the signal quality thresholds in the second sequence one by one in sequence from a first signal quality threshold in the second sequence;
determine, in the case that the signal quality measurement result is determined to be greater than or equal to an i^{th} signal quality threshold in the second sequence, an i^{th} wake-up signal format in the first sequence as the target wake-up signal format, where i is a positive integer less than or equal to N−1; and
determine, in the case that the signal quality measurement result is less than an (N−1)^{th} signal quality threshold in the second sequence, an N^{th} wake-up signal format in the first sequence as the target wake-up signal format.

In some embodiments, the signal quality range corresponding to the target wake-up signal format includes value ranges respectively corresponding to M measurement quantities, where M is an integer greater than 1; and
the signal quality measurement result includes measurement results respectively corresponding to the M measurement quantities, and the measurement result corresponding to each measurement quantity meets the value range corresponding to the measurement quantity;
or,
the signal quality measurement result includes a measurement result corresponding to at least one measurement quantity, and there is a measurement result corresponding to at least one measurement quantity that meets the value range corresponding to the measurement quantity.

In some embodiments, the sending module 1020 is further configured to send second information to the terminal device, the second information being configured to instruct the terminal device to wake up based on the target wake-up signal format.

In some embodiments, the wake-up signal format corresponds to a low power wake-up signal, and the target wake-up signal format is configured to trigger the terminal device to switch from a low power mode to a non-low power mode.

In some embodiments, the signal quality measurement result includes a measurement result corresponding to at least one of the following measurement quantities: RSRP, RSRQ, or SINR.

Referring to FIG. 11, a block diagram of an apparatus for waking up a terminal device according to some embodiments of the present disclosure is shown. The apparatus has the function of implementing the above method for waking up the terminal device on the terminal device side, and the function can be achieved by hardware or by hardware executing corresponding software. In some embodiments, the apparatus is the terminal device described above, or provided in the terminal device. As shown in FIG. 11, in some embodiments, the apparatus 1100 includes: a sending module 1110 and a receiving module 1120.

The sending module 1110 is configured to report a signal quality measurement result regarding a downlink signal to a network device.

The receiving module 1120 is configured to receive a target wake-up signal format from the network device, wherein the target wake-up signal format is a wake-up signal format selected by the network device from a plurality of different wake-up signal formats based on the signal quality measurement result, and the different wake-up signal formats correspond to different quantities of repetitive signal transmissions.

In some embodiments, the quantity of repetitive signal transmissions corresponding to the wake-up signal format is in a positive correlation with the signal coverage area corresponding to the wake-up signal format.

In some embodiments, the signal quality characterized by the signal quality measurement result is in a negative correlation with the quantity of repetitive signal transmissions corresponding to the target wake-up signal format.

In some embodiments, the receiving module 1120 is further configured to receive second information from the network device, the second information being configured to instruct the terminal device to wake up based on the target wake-up signal format.

In some embodiments, the wake-up signal format corresponds to a low power wake-up signal, and the target wake-up signal format is configured to trigger the terminal device to switch from a low power mode to a non-low power mode.

In some embodiments, the signal quality measurement result includes a measurement result corresponding to at least one of the following measurement quantities: RSRP, RSRQ, or SINR.

With regard to the apparatus in the above embodiments, the specific manner in which each module performs its operation has been described in detail in the embodiments related to the method and will not be described in detail herein. It should be noted that the division of the functional modules is merely exemplary to ensure that the apparatus according to the above embodiment can implement the functions thereof. In practical applications, the above functions can be assigned to different functional modules as needed, that is, the internal structure of the device may be divided into different functional modules, so as to implement all or a part of the above functions. In addition, the apparatuses according to the above embodiments have the same concept with the method embodiments, and specific implementation processes thereof are described in the method embodiments in detail, which are not described herein any further.

Referring to FIG. 12, a schematic structural diagram of a terminal device 1200 according to some embodiments of the present disclosure is shown. The terminal device 1200 is configured to perform the relevant method steps executed by the terminal device in the above embodiments. In some embodiments, the terminal device 1200 includes: a processor 1201, a transceiver 1202, and a memory 1203.

The processor 1201 includes one or more processing cores, and the processor 1201 executes various functional applications and information processing by running software programs and modules.

In some embodiments, the transceiver 1202 includes a receiver and a transmitter. In some embodiments, the receiver and the transmitter are implemented as a same radio communication assembly that includes a radio communication chip and a radio frequency antenna.

In some embodiments, the memory 1203 is connected to the processor 1201 and the transceiver 1202.

In some embodiments, the memory 1203 is configured to store a computer program executed by the processor, and the processor 1201 is configured to execute the computer program to perform the steps executed by the terminal device in the above method embodiments.

In addition, the memory 1203 is implemented by any type or combination of volatile or non-volatile storage devices including, but not limited to: magnetic or optical disks, electrically erasable programmable read-only memories, erasable programmable read-only memories, static random access memories, read-only memories, magnetic memories, flash memories, and programmable read-only memories.

In an exemplary embodiment, the processor 1201 is configured to select, based on a signal quality measurement result regarding a downlink signal, a target wake-up signal format from a plurality of different wake-up signal formats, and wake up based on the target wake-up signal format; wherein different wake-up signal formats correspond to different quantities of repetitive signal transmissions.

In another example embodiment, the transceiver 1202 is configured to report a signal quality measurement result regarding a downlink signal to a network device, and receive a target wake-up signal format from the network device, wherein the target wake-up signal format is a wake-up signal format selected by the network device from a plurality of different wake-up signal formats based on the signal quality measurement result, and different wake-up signal formats correspond to different quantities of repetitive signal transmissions.

For the details which are not described in detail in the above embodiments, reference is made to the description in the above method embodiments, which are not described herein any further.

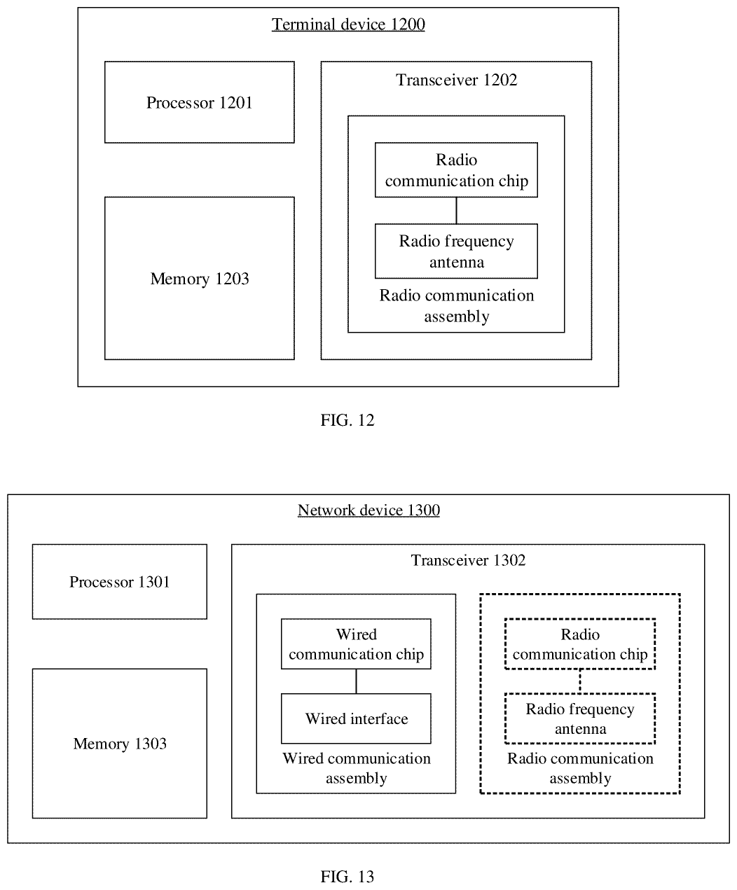

Referring to FIG. 13, a schematic structural diagram of a network device 1300 according to some embodiments of the present disclosure is shown. The network device 1300 is configured to perform the relevant method steps executed by the network device in the above embodiments. In some embodiments, the network device 1300 includes: a processor 1301, a transceiver 1302, and a memory 1303.

The processor 1301 includes one or more processing cores, and the processor 1301 performs various functional applications and information processing by running software programs and modules.

In some embodiments, the transceiver 1302 includes a receiver and a transmitter. In some embodiments, the transceiver 1302 includes a wired communication assembly which includes a wired communication chip and a wired interface (e.g., a fiber optic interface). In some embodiments, the transceiver 1302 further includes a radio communication assembly which includes a radio communication chip and a radio frequency antenna.

In some embodiments, the memory 1303 is connected to the processor 1301 and the transceiver 1302.

In some embodiments, the memory 1303 is configured to store a computer program executed by the processor, and the processor 1301 is configured to execute the computer program to perform the steps executed by the network device in the above method embodiments.

In addition, in some embodiments, the memory 1303 is implemented by any type or combination of volatile or non-volatile storage devices including, but not limited to: magnetic or optical disks, electrically erasable programmable read-only memories, erasable programmable read-only memories, static random access memories, read-only memories, magnetic memories, flash memories, and programmable read-only memories.

In an exemplary embodiment, the processor 1301 is configured to select, based on a signal quality measurement result regarding a downlink signal reported by a terminal device, a target wake-up signal format from a plurality of different wake-up signal formats; wherein different wake-up signal formats correspond to different quantities of repetitive signal transmissions, and the target wake-up signal format is configured to wake up the terminal device. The transceiver 1302 is configured to send the target wake-up signal format to the terminal device.

For the details which are not described in detail in the above embodiments, reference is made to the description in the above method embodiments, which are not described herein any further.

The embodiments of the present disclosure further provide a computer-readable storage medium storing a computer program therein, wherein the computer program, when loaded and executed by a processor of a terminal device or a network device, causes the terminal device or the network device to perform the method for selecting the wake-up signal format or the method for waking up the terminal device described above.

In some embodiments, the computer-readable storage medium includes: a read-only memory (ROM), a random-access memory (RAM), a solid-state drive (SSD), an optical disk, and the like. In some embodiments, the RAM includes a resistance random-access memory (ReRAM) and a dynamic random-access memory (DRAM).

The embodiments of the present disclosure further provide a chip including a programmable logic circuit and/or a program instruction, wherein the chip, when running on a terminal device or a network device, causes the terminal device or the network device to perform the method for selecting the wake-up signal format or the method for waking up the terminal device described above.

The embodiments of the present disclosure further provide a computer program product or a computer program including a computer instruction stored in a computer-readable storage medium, wherein the computer instruction, when loaded from the computer-readable storage medium and executed by a processor of a terminal device or a network device, causes the terminal device or the network device to perform the method for selecting the wake-up signal format or the method for waking up the terminal device described above.

It should be understood that “indication” mentioned in the embodiments of the present disclosure may be a direct indication, an indirect indication, or an indication that there is an association. For example, A indicates B, which can mean that A indicates B directly, e.g., B may be acquired by A; or that A indicates B indirectly, e.g., A indicates C by which B may be acquired; or that an association is present between A and B.

In the description of the embodiments of the present disclosure, the term “corresponding” may refer to a direct correspondence or an indirect correspondence that is present between two items, may refer to an association that is present between two items, or may refer to other relationships such as indicating and being indicated, configuring and being configured.

The mentioned term “a plurality of” herein means two or more. The term “and/or” describes the association relationship of the associated objects, and indicates that three relationships may be present. For example, A and/or B may indicate that: only A is present, both A and B are present, and only B is present. The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the steps described herein only show an exemplary possible execution sequence among the steps, and in some other embodiments, the steps may also be executed out of the numbering sequence, for example, two steps with different serial numbers are executed simultaneously, or two steps with different serial numbers are executed in a reverse order to the illustrated sequence, which is not limited in the present disclosure.

Those skilled in the art should understand that in one or more of the above embodiments, the functions described in the embodiments of the present disclosure can be implemented by hardware, software, firmware, or any combination thereof. The functions, when implemented by software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general purpose or special purpose computer.

Described above are merely exemplary embodiments of the present disclosure and are not intended to limit the present disclosure. Any modifications, equivalent substitutions, improvements, and the like, made within the concept and principle of the present disclosure should fall within the protection scope of the present disclosure.

1. A method for selecting a wake-up signal format, comprising:
selecting, by a terminal device, a target wake-up signal format from a plurality of different wake-up signal formats based on a signal quality measurement result regarding a downlink signal; wherein the different wake-up signal formats correspond to different quantities of repetitive signal transmissions; and
waking up the terminal device based on the target wake-up signal format.

2. The method according to claim 1, wherein the quantity of repetitive signal transmissions corresponding to the wake-up signal format is in a positive correlation with a signal coverage area corresponding to the wake-up signal format.

3. The method according to claim 1, wherein signal quality characterized by the signal quality measurement result is in a negative correlation with the quantity of repetitive signal transmissions corresponding to the target wake-up signal format.

4. The method according to claim 1, wherein selecting, by the terminal device, the target wake-up signal format from the plurality of different wake-up signal formats based on the signal quality measurement result regarding the downlink signal comprises:
determining, by the terminal device, a wake-up signal format corresponding to a target signal quality range to which the signal quality measurement result belongs as the target wake-up signal format based on signal quality ranges respectively corresponding to the plurality of different wake-up signal formats.

5. The method according to claim 4, wherein signal quality ranges respectively corresponding to N different wake-up signal formats are determined based on N−1 signal quality thresholds, where N is an integer greater than 1; and
determining, by the terminal device, the wake-up signal format corresponding to the target signal quality range to which the signal quality measurement result belongs as the target wake-up signal format based on the signal quality ranges respectively corresponding to the plurality of different wake-up signal formats comprises:
acquiring, by the terminal device, a first sequence by sorting the N different wake-up signal formats according to a sequence of corresponding quantities of repetitive signal transmissions from small to large;
acquiring, by the terminal device, a second sequence by sorting the N−1 signal quality thresholds from large to small;
comparing, by the terminal device, the signal quality measurement result with the signal quality thresholds in the second sequence one by one in sequence from a first signal quality threshold in the second sequence;
in a case that the signal quality measurement result is determined to be greater than or equal to an i^{th} signal quality threshold in the second sequence, determining, by the terminal device, an i^{th} wake-up signal format in the first sequence as the target wake-up signal format, where i is a positive integer less than or equal to N−1; and
in a case that the signal quality measurement result is less than an (N−1)^{th} signal quality threshold in the second sequence, determining, by the terminal device, an N^{th} wake-up signal format in the first sequence as the target wake-up signal format.

6. The method according to claim 4, wherein a signal quality range corresponding to the target wake-up signal format comprises value ranges respectively corresponding to M measurement quantities, where M is an integer greater than 1; and
the signal quality measurement result comprises measurement results respectively corresponding to the M measurement quantities, and the measurement result corresponding to each measurement quantity meets the value range corresponding to the measurement quantity;
or,
the signal quality measurement result comprises a measurement result corresponding to at least one measurement quantity, and there is a measurement result corresponding to at least one measurement quantity that meets the value range corresponding to the measurement quantity.

7. The method according to claim 1, wherein upon selecting, by the terminal device, the target wake-up signal format from the plurality of different wake-up signal formats based on the signal quality measurement result regarding the downlink signal, the method further comprises:
sending, by the terminal device, first information to a network device, the first information being configured to instruct the network device to wake up the terminal device by using the target wake-up signal format.

8. The method according to claim 1, further comprising:
receiving, by the terminal device, configuration information from a network device;
wherein the configuration information comprises at least one of: the numbers of repeated signal transmissions respectively corresponding to the plurality of different wake-up signal formats, and the signal quality ranges respectively corresponding to the plurality of different wake-up signal formats.

9. The method according to claim 1, wherein the wake-up signal format corresponds to a low power wake-up signal, and the target wake-up signal format is configured to trigger the terminal device to switch from a low power mode to a non-low power mode.

10. The method according to claim 1, wherein the signal quality measurement result comprises a measurement result corresponding to at least one of the following measurement quantities: reference signal receiving power (RSRP), reference signal receiving quality (RSRQ), or signal to interference plus noise ratio (SINR).

11. A method for waking up a terminal device, comprising:
reporting, by the terminal device, a signal quality measurement result regarding a downlink signal to a network device; and
receiving, by the terminal device, a target wake-up signal format from the network device, wherein the target wake-up signal format is a wake-up signal format selected by the network device from a plurality of different wake-up signal formats based on the signal quality measurement result, and the different wake-up signal formats correspond to different quantities of repetitive signal transmissions.

12. The method according to claim 11, wherein the quantities of repetitive signal transmissions corresponding to the wake-up signal format is in a positive correlation with a signal coverage area corresponding to the wake-up signal format.

13. The method according to claim 11, wherein signal quality characterized by the signal quality measurement result is in a negative correlation with the quantity of repetitive signal transmissions corresponding to the target wake-up signal format.

14. The method according to claim 11, wherein upon reporting, by the terminal device, the signal quality measurement result regarding the downlink signal to the network device, the method further comprises:
receiving, by the terminal device, second information from the network device, the second information being configured to instruct the terminal device to wake up based on the target wake-up signal format.

15. The method according to claim 11, wherein the wake-up signal format corresponds to a low power wake-up signal, and the target wake-up signal format is configured to trigger the terminal device to switch from a low power mode to a non-low power mode.

16. The method according to claim 11, wherein the signal quality measurement result comprises a measurement result corresponding to at least one of the following measurement quantities: reference signal receiving power (RSRP), reference signal receiving quality (RSRQ), or signal to interference plus noise ratio (SINR).

17. A network device, comprising a processor and a memory storing a computer program therein, wherein the processor, when loading and executing the computer program, is caused to perform:
selecting a target wake-up signal format from a plurality of different wake-up signal formats based on a signal quality measurement result regarding a downlink signal reported by a terminal device; wherein the different wake-up signal formats correspond to different quantities of repetitive signal transmissions, and the target wake-up signal format is configured to wake up the terminal device; and
sending the target wake-up signal format to the terminal device.

18. The network device according to claim 17, wherein the quantity of repetitive signal transmissions corresponding to the wake-up signal format is in a positive correlation with a signal coverage area corresponding to the wake-up signal format.

19. The network device according to claim 17, wherein signal quality characterized by the signal quality measurement result is in a negative correlation with the quantity of repetitive signal transmissions corresponding to the target wake-up signal format.

20. The network device according to claim 17, wherein the processor, when loading and executing the computer program, is caused to further perform:
determining a wake-up signal format corresponding to a target signal quality range to which the signal quality measurement result belongs as the target wake-up signal format based on signal quality ranges respectively corresponding to the plurality of different wake-up signal formats.
